(19) United States
(12) Patent Application Publication
(10) Pub. No.: US 2022/0111626 A1
(43) Pub. Date: Apr. 14, 2022

(54) FILM COATING METHOD USING ENGRAVING ROLLER SYSTEM

(71) Applicant: BASF SE, Ludwigshafen am Rhein (DE)

(72) Inventors: Karl-Heinz SCHUMACHER, Ludwigshafen am Rhein (DE); Bernd HOEVEL, Ludwigshafen am Rhein (DE)

(21) Appl. No.: 17/421,887

(22) PCT Filed: Dec. 20, 2019
(86) PCT No.: PCT/EP2019/086574

§ 371 Date: Jul. 9, 2021

(30) Foreign Application Priority Data
Jan. 11, 2019 (EP) 19151452.0

(51) Int. Cl. B32B 37/12; C08K 5/053; C09J 175/06; C09J 133/06; C09J 175/08

(52) U.S. Cl. CPC B32B 37/1284; C08K 5/053; C09J 175/06; C09J 133/06; C08L 71/02; B32B 2037/1276; B32B 2405/00; B32B 2307/412; C08G 2170/80; C09J 175/08

(57) ABSTRACT

Described is a process for film lamination, wherein an aqueous laminating adhesive is applied to a carrier film by means of a gravure roller system (direct gravure coating system), wherein the carrier film and/or an optional substrate are transparent, and the aqueous laminating adhesive comprises (a) an adhesive polymer dispersed in the aqueous phase and (b) a polyalkylene glycol dissolved in the aqueous phase, selected from polyethylene glycol and polypropylene glycol.

The invention relates to a process for film lamination, wherein an aqueous laminating adhesive is applied to a carrier film by means of a gravure roller system (direct gravure coating system), wherein the carrier film and/or an optional substrate are preferably transparent and the aqueous laminating adhesive comprises an adhesive polymer dispersed in the aqueous phase and a polyalkylene glycol selected from polyethylene glycol and polypropylene glycol dissolved in the aqueous phase.

Dispersed adhesive polymers comprising aqueous laminating adhesives are applied to carrier films by means of suitable application systems and are said to result in an optically defect-free clear coating appearance especially when the carrier films are transparent. Aqueous adhesives for laminating applications are described for example in WO 98/23656, WO 00/50480 and WO 2017/102497. Common application systems include gravure roller systems, in which the carrier film to be coated moves between two rollers, which rotate in the direction of the moving web (so-called direct gravure coating system). One of these rollers is a roller (made of steel for example) comprising an engraving by means of which the laminating adhesive is applied to the carrier film. The second roller is typically a rubber roller (so-called backing roller).

After the coating of the carrier film (primary film) with the aqueous laminating adhesive said film passes into a dryer to evaporate the water from the adhesive. A second substrate (for example a second film (secondary film)) for producing composite films or paper/printed or unprinted card for producing film/paper laminates is subsequently colaminated under elevated temperature and pressure using a calendar. Use of the described coating technology causes the adhesive layer to experience mechanical forces during application in the roller nip which result in a more or less uneven surface of the still-liquid adhesive layer upon exiting the roller nip. If this surface structure of the liquid adhesive layer does not smooth out on the way into the dryer this structure is fixed in the dryer. If the primary film is a transparent film or if a transparent secondary film is colaminated these surface structures of the adhesive become visible in the resulting film laminate, the laminate appears cloudy and fails to achieve the desired clarity. Even in the case of fully printed (i.e. nontransparent) films this undesired structure in the adhesive may become apparent as a distortion in the printed image.

This problem of sufficient smoothing of the adhesive film before drying thereof may be solved mechanically by using a smoothing bar to smooth the wet adhesive film. However, when using such a smoothing bar there is a risk of adhesive residues drying on the smoothing bar and leading to coating defects. This may occur especially if the coating plant is stopped due to technical problems for example.

The object was to provide a process for mechanical coating of films with aqueous adhesive dispersions, in the case of which without the use of a smoothing bar a fastest possible smoothing of the wet adhesive film is effected before the film web reaches the dryer and ideally defect-free, optically clear coatings are achieved when using preferably transparent films as the primary and/or secondary film.

It has now been found that addition of particular additives to the aqueous laminating adhesive makes it possible to avoid defects in the coating image without needing to employ a smoothing roller. Suitable additives are polyalkylene glycols selected from polyethylene glycol, polypropylene glycol and mixtures thereof dissolved in the aqueous phase.

The invention provides a process for film lamination, wherein an aqueous laminating adhesive is applied to a carrier film by means of an application system, wherein the application system is a gravure roller system, wherein the carrier film to be coated moves between two rollers which rotate in the direction of the moving carrier film web (so-called direct gravure coating system), wherein one of the rollers is a gravure roller and the laminating adhesive is applied to the carrier film by the gravure roller, wherein the adhesive-coated carrier film (primary film) is optionally bonded to a further substrate, wherein the carrier film and/or the optional substrate (for example a secondary film) are preferably transparent or printed,

wherein the aqueous laminating adhesive comprises

(a) at least one adhesive polymer dispersed in the aqueous phase and

(b) at least one polyalkylene glycol dissolved in the aqueous phase, selected from polyethylene glycol, polypropylene glycol and a mixture thereof.

The invention also provides for the use of at least one polyalkylene glycol selected from polyethylene glycol having a molecular weight of more than 100 and up to 1500, preferably of 300 to 600, and polypropylene glycol having a molecular weight of more than 100 and up to 2000, preferably from 300 to 600, in the production of carrier films coated with an aqueous laminating adhesive using an application system, wherein the application system is a gravure roller system, wherein the carrier film to be coated moves between two rollers which rotate in the direction of the moving carrier film web (direct gravure coating system), wherein one of the rollers is a gravure roller and the laminating adhesive is applied to the carrier film by the gravure roller, wherein the adhesive-coated carrier film is optionally bonded to a further substrate, wherein the carrier film and/or the optional substrate are preferably transparent or printed. The molecular weights are average molecular weights calculated from the OH number according to DIN 53240-3:2016-03.

The text below occasionally uses the designation “(meth)acrylic” or “(meth)acrylate” and similar as an abbreviating notation for “acrylic or methacrylic” or “acrylate or methacrylate”. In the designation Cx-alkyl (meth)acrylate and analogous designations, x denotes the number of carbon atoms in the alkyl group.

The glass transition temperature is determined by differential scanning calorimetry (ASTM D 3418-08, so-called midpoint temperature). The glass transition temperature of the polymer in the polymer dispersion is the glass transition temperature obtained when evaluating the second heating curve (heating rate 20° C./min).

The aqueous laminating adhesive preferably comprises

(i) from 30% to 60% by weight, particularly preferably from 40% to 55% by weight, of the at least one adhesive polymer and

(ii) from 0.25% to 3% by weight, particularly preferably from 0.5% to 1.5% by weight, of the at least one polyalkylene glycol dissolved in the aqueous phase; and optionally further constituents.

The aqueous laminating adhesive comprises at least one polyalkylene glycol. The polyalkylene glycol is either the homopolymer of polyethylene glycol or the homopolymer of polypropylene glycol. A mixture of these two homopolymers may also be employed. The polyalkylene glycols are present in the aqueous laminating adhesive composition in dissolved form. They have a water solubility of preferably at least 10 g/I and are preferably completely soluble in the aqueous phase in any mixing ratio.

The polyethylene glycol has an average molecular weight of preferably more than 100 and up to 1500, preferably of 300 to 600. The polypropylene glycol has an average molecular weight of preferably more than 100 and up to 2000 or of more than 100 and up to 1000, preferably of 300 to 600. Particular preference is given to polypropylene glycol having an average molecular weight of 400 to 500. The molecular weights are average molecular weights calculated from the OH number according to DIN 53240-3:2016-03.

The aqueous laminating adhesive comprises at least one adhesive polymer dispersed in the adhesive composition. The adhesive polymer dispersed in the aqueous laminating adhesive has a glass transition temperature of preferably −40° C. to +15° C., particularly preferably from −35° C. to 0° C.

The adhesive polymer is preferably selected from polyurethanes and polymers producible by free-radical emulsion polymerization of ethylenically unsaturated, free-radically polymerizable monomers, also referred to hereinbelow as emulsion polymer. The free-radically polymerizable monomers preferably comprise
a) at least 60% by weight, based on the total amount of monomers, of at least one monomer selected from the group consisting of C1- to C20-alkyl acrylates, C1- to C20-alkyl methacrylates, vinyl esters of carboxylic acids comprising up to 20 carbon atoms, vinylaromatics having up to 20 carbon atoms, vinyl halides, vinyl ethers of alcohols comprising 1 to 10 carbon atoms, aliphatic hydrocarbons having 2 to 8 carbon atoms and one or two double bonds, and mixtures of these monomers,
b) at least 0.1% by weight, based on the total amount of monomers, of at least one monomer having at least one acid group, preferably selected from the group consisting of acrylic acid, methacrylic acid, itaconic acid, maleic acid, fumaric acid, crotonic acid, vinylacetic acid, vinyllactic acid, vinylsulfonic acid, styrenesulfonic acid, acrylamidomethylpropanesulfonic acid, sulfopropyl acrylate, sulfopropyl methacrylate and mixtures of these monomers;
c) optionally at least one further monomer distinct from the monomers a) and b).

The adhesive polymer is preferably producible by free-radical emulsion polymerization of ethylenically unsaturated, free-radically polymerizable monomers comprising
a) 60% to 99.9% by weight, based on the total amount of monomers, of at least one monomer selected from the group consisting of C1- to C20-alkyl acrylates, C1- to C20-alkyl methacrylater, vinylaromatics having up to 20 carbon atoms, and
b) 0.1% to 5% by weight, based on the total amount of monomers, of at least one monomer having at least one acid group selected from acrylic acid, methacrylic acid and itaconic acid and
c) 0% to 10% by weight, based on the total amount of monomers, of further monomers distinct from the monomers a) to b), selected from the group consisting of acrylamide, methacrylamide, N-methylolacrylamide, N-methylolmethacrylamide, phenyloxyethylglycol mono(meth)acrylate, hydroxyl-comprising monomers, amino-comprising monomers, nitriles, alpha,beta-monoethylenically unsaturated C3-C8-carboxylic acids, bifunctional monomers which comprise not only an ethylenically unsaturated double bond but also at least one glycidyl group, oxazoline group, ureido group or ureido-analogous group, and crosslinking monomers having more than one free-radically polymerizable group.

The monomers a) are preferably employed in an amount of at least 80% by weight based on the total amount of the monomers and are selected from the group consisting of C1- to C10-alkyl acrylates, C1- bis C10-alkyl methacrylates, styrene and a mixture thereof. The monomers b) are preferably employed in an amount of 0.5% to 5% by weight based on the total amount of the monomers and are selected from the group consisting of acrylic acid, methacrylic acid, itaconic acid and a mixture thereof.

Monomers a)

The monomer mixture preferably consists of at least 60% by weight, preferably to an extent of at least 80% by weight, for example from 60% to 99.9% by weight or from 80% to 99.9% by weight or from 80% to 98% by weight, particularly preferably to an extent of at least 90% by weight, based on the total amount of monomers, of at least one monomer a) selected from the group consisting of C1- to C20-alkyl acrylates, C1- to C20-alkyl methacrylates, vinyl esters of carboxylic acids comprising up to 20 carbon atoms, vinylaromatics having up to 20 carbon atoms, vinyl halides, vinyl ethers of alcohols comprising 1 to 10 carbon atoms, aliphatic hydrocarbons having 2 to 8 carbon atoms and one or two double bonds, and mixtures of these monomers.

Suitable monomers a) are for example (meth)acrylic acid alkyl esters having a C₁-C₁₀-alkyl radical, such as methyl methacrylate, methyl acrylate, n-butyl acrylate, ethyl acrylate and 2-ethylhexyl acrylate, and also behenyl (meth)acrylate, isobutyl acrylate, tert-butyl (meth)acrylate and cyclohexyl (meth)acrylate. In particular, mixtures of the (meth)acrylic acid alkyl esters are also suitable.

Vinyl esters of carboxylic acids having 1 to 20 carbon atoms are, for example, vinyl laurate, vinyl stearate, vinyl propionate, Versatic acid vinyl esters, and vinyl acetate. Contemplated vinylaromatic compounds include vinyltoluene, alpha- and para-methylstyrene, alpha-butylstyrene, 4-n-butylstyrene, 4-n-decylstyrene and, preferably, styrene. The vinyl halides are ethylenically unsaturated compounds substituted by chlorine, fluorine or bromine, preferably vinyl chloride and vinylidene chloride. Examples of vinyl ethers include for example vinyl methyl ether or vinyl isobutyl ether. Vinyl ethers of alcohols comprising 1 to 4 carbon atoms are preferred. Hydrocarbons having 4 to 8 carbon atoms and two olefinic double bonds include butadiene, isoprene and chloroprene. Preferred monomers a) include the C₁- to C₁₀-alkyl acrylates, C₁- to C₁₀-alkyl methacrylates, in particular C₁- to C₈-alkyl acrylates and methacrylates and also styrene and mixtures thereof. Especially particularly preferred are methyl acrylate, methyl methacrylate, ethyl acrylate, n-butyl acrylate, n-butyl methacrylate, n-hexyl acrylate, octyl acrylate and 2-ethylhexyl acrylate, 2-propylheptyl acrylate, styrene and also mixtures of these monomers.

Monomers b)

The monomer mixture preferably consists to an extent of at least 0.1% by weight, in particular from 0.1% to 5% by weight or from 0.5% to 3% by weight, based on the total amount of monomers, of at least one ethylenically unsaturated monomer having at least one acid group (acid monomer). The acid monomers b) comprise not only monomers comprising at least one acid group but also anhydrides thereof and salts thereof. The monomers b) include alpha,beta-monoethylenically unsaturated monocarboxylic and dicarboxylic acids, half-esters of alpha,beta-monoethylenically unsaturated dicarboxylic acids, the anhydrides of the abovementioned alpha,beta-monoethylenically unsaturated carboxylic acids and also ethylenically unsaturated sulfonic acids, phosphonic acids or dihydrogenphosphates and water-soluble salts thereof, for example alkali metal salts thereof. Examples thereof are acrylic acid, methacrylic acid, itaconic acid, maleic acid, fumaric acid, crotonic acid, vinylacetic acid and vinyllactic acid. Examples of suitable ethylenically unsaturated sulfonic acids include vinylsulfonic acid, styrenesulfonic acid, acrylamidomethylpropanesulfonic acid, sulfopropyl acrylate and sulfopropyl methacrylate. Preferred monomers b) are alpha,beta-monoethylenically unsaturated C3-C8-carboxylic acids and C4-C8-dicarboxylic acids, for example itaconic acid, crotonic acid, vinylacetic acid, acrylamidoglycolic acid, acrylic acid and methacrylic acid and also anhydrides thereof. Particularly preferred monomers b) are itaconic acid, acrylic acid and methacrylic acid.

The acid groups of the monomer b) may still be present in unneutralized form at the beginning of the polymerization and be fully or partially neutralized by feeding of a base only during or after the emulsion polymerization, wherein for example the feeding of the base commences during the emulsion polymerization (i.e. after commencement of the polymerization reaction) once at least 5% by weight, preferably 10% to 70% by weight, of the total monomer mixture is present in the reaction vessel under polymerization conditions. The neutralizing agent may be added for example in a separate feed simultaneously with the feeding of the monomer mixture. After feeding of all of the monomers, the polymerization vessel preferably contains the amount of neutralizing agent required for neutralizing at least 10%, preferably 10% to 100% or 25% to 90%, of acid equivalents. Suitable bases are, for example, sodium hydroxide solution, potassium hydroxide solution, ammonia (preferably in aqueous solution) or organic amines, preferably tertiary amines, in particular trialkylamines preferably having 1 to 4 carbon atoms in the alkyl group, such as for example triethylamine.

Monomers c)

The monomer mixture may optionally comprise at least one further monomer c) distinct from the monomers a) and b). The monomers c) may be employed for example in amounts of from 0% to 10% by weight or from 0% to 5% by weight, in particular from 0.1% to 10% by weight or from 0.1% to 5% by weight or from 0.2% to 3% by weight, based on the total amount of monomers.

Monomers c) are, for example, neutral and/or nonionic monomers having elevated solubility in water, for example the amides or the N-alkylolamides of the abovementioned ethylenically unsaturated carboxylic acids, for example acrylamide, methacrylamide, N-methylolacrylamide and N-methylolmethacrylamide or phenyloxyethyl glycol mono(meth)acrylate. Monomers c) further include, for example, hydroxyl-comprising monomers, in particular the hydroxyalkyl esters of the abovementioned alpha,beta-monoethylenically unsaturated carboxylic acids, preferably C₁-C₁₀-hydroxyalkyl (meth)acrylates, such as for example hydroxyethyl acrylate, hydroxyethyl methacrylate, hydroxypropyl acrylate or hydroxypropyl methacrylate, and also 4-hydroxybutyl acrylate.

Monomers c) further include, for example, also amino-comprising monomers, in particular the aminoalkyl esters of the abovementioned alpha,beta-monoethylenically unsaturated carboxylic acids, preferably C₁-C₁₀-aminoalkyl (meth)acrylates, such as for example 2-aminoethyl (meth)acrylate or tert-butylaminoethyl methacrylate. Additionally contemplated as monomers c) are the nitriles of alpha,beta-monoethylenically unsaturated C3-C8-carboxylic acids, such as for example acrylonitrile or methacrylonitrile.

Suitable monomers c) also include bifunctional monomers which comprise not only an ethylenically unsaturated double bond but also at least one glycidyl group, oxazoline group, ureido group, ureido-analogous group or carbonyl group, and crosslinking monomers having more than one free-radically polymerizable group. Examples of glycidyl group monomers are ethylenically unsaturated glycidyl ethers and glycidyl esters, for example vinyl, allyl and methallyl glycidyl ethers, and glycidyl (meth)acrylate. Examples of carbonyl group monomers are the diacetonylamides of the abovementioned ethylenically unsaturated carboxylic acids, for example diacetone(meth)acrylamide, and the esters of acetylacetic acid with the abovementioned hydroxyalkyl esters of ethylenically unsaturated carboxylic acids, for example acetylacetoxyethyl (meth)acrylate.

Examples of oxazoline group monomers c) are those of the formula:

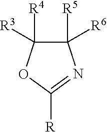

wherein the radicals are defined as follows:

R is a C₂₋₂₀-alkenyl radical comprising at least one ethylenically unsaturated group; R³, R⁴, R⁵ and R⁶ are independently of one another selected from H, halogen, C₁₋₂₀-alkyl, C₂₋₂₀-alkenyl, C₆₋₂₀-aryl, C₇₋₃₂-arylalkyl, C₁₋₂₀-hydroxyalkyl, C₁₋₂₀-aminoalkyl and C₁₋₂₀-haloalkyl, preferably selected from H, halogen and C₁₋₂₀-alkyl.

The oxazoline monomers are especially preferably at least one monomer selected from the group consisting of 2-vinyl-2-oxazoline, 2-vinyl-4-methyl-2-oxazoline, 2-vinyl-5-methyl-2-oxazoline, 2-vinyl-4-ethyl-2-oxazoline, 2-vinyl-4,4-dimethyl-2-oxazoline, 2-vinyl-5,5-dimethyl-2-oxazoline, 2-vinyl-4,4,5,5-teramethyl-2-oxazoline, 2-isopropenyl-2-oxazoline, 2-isopropenyl-4-methyl-2-oxazoline, 2-isopropenyl-5-methyl-2-oxazoline, 2-isopropenyl-4-ethyl-2-oxazoline, 2-isopropenyl-5-ethyl-2-oxazoline, 2-isopropenyl-4,4-dimethyl-2-oxazoline, 2-isopropenyl-5,5-dimethyl-2-oxazoline and 2-isopropenyl-4,4,5,5-tetramethyl-2-oxazoline. The use of 2-vinyl-2-oxazoline and/or 2-isopropenyl-2-oxazoline is particularly preferred; 2-isopropenyl-2-oxazoline (iPOx) is especially preferred.

Examples of ureido group or ureido-analogous group monomers c) are, for example, those of the formula

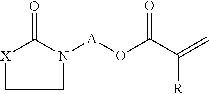

wherein X is CH₂, O, NH or NR¹ and R¹ is a C1- to C4-alkyl group, R is hydrogen or methyl, and A is a divalent linking group, preferably a C1- to C10-alkyl group or a C2- to C4-alkyl group. Particularly preferred are ureidoalkyl (meth)acrylates having 1 to 10 carbon atoms, preferably 2 to 4 carbon atoms, in the alkyl group, in particular ureidoethyl methacrylate (UMA).

Further examples of monomers c) are crosslinking monomers which have more than one free-radically polymerizable group, in particular two or more (meth)acrylate groups, such as butanediol di(meth)acrylate or allyl methacrylate, for example.

Preferred monomers c) are those which allow postcrosslinking of the polymer, for example with polyfunctional amines, hydrazides, isocyanates or alcohols. Crosslinking is also possible through metal-salt crosslinking of the carboxyl groups, using polyvalent metal cations, e.g. Zn or Al.

Suitable crosslinking may be accomplished, for example, by the polymer comprising keto groups or aldehyde groups (preferably 0.0001 to 1 mol, or 0.0002 to 0.10 mol, or 0.0006 to 0.03 mol) and the polymer dispersion additionally comprising a compound having at least 2 functional groups, in particularl 2 to 5 functional groups, which enter into a crosslinking reaction with the keto or aldehyde groups. The keto or aldehyde groups may be bonded to the polymer through copolymerization of suitable monomers c). Suitable monomers c) are, for example, acrolein, methacrolein, vinyl alkyl ketones having 1 to 20, preferably 1 to 10, carbon atoms in the alkyl radical, formylstyrene, (meth)acrylic acid alkyl esters having one or two keto or aldehyde groups, or one aldehyde group and one keto group, in the alkyl radical, the alkyl radical preferably comprising a total of 3 to 10 carbon atoms, e.g. (meth)acryloyloxyalkylpropanals. N-oxoalkyl(meth)acrylamides are moreover also suitable. Particularly preferred are acetoacetyl(meth)acrylate, acetoacetoxyethyl(meth)acrylate and especially diacetoneacrylamide.

Examples of compounds which are able to enter into a crosslinking reaction with the keto or aldehyde groups are compounds having hydrazide, hydroxylamine, oxime ether or amino groups. Suitable compounds having hydrazide groups are, for example, polycarboxylic hydrazides having a molar weight of up to 500 g/mol. Preferred hydrazide compounds are dicarboxylic dihydrazides having preferably 2 to 10 carbon atoms. Examples include oxalic dihydrazide, malonic dihydrazide, succinic dihydrazide, glutaric dihydrazide, adipic dihydrazide, sebacic dihydrazide, maleic dihydrazide, fumaric dihydrazide, itaconic dihydrazide and/or isophthalic dihydrazide. Particularly preferred are adipic dihydrazide, sebacic dihydrazide and isophthalic dihydrazide. Examples of suitable compounds having amino groups are ethylenediamine, propylenediamine, tetramethylenediamine, pentamethylenediamine, hexamethylenediamine, diethylenetriamine, triethylenetetramine, polyethyleneimines, partly hydrolyzed polyvinylformamides, ethylene oxide and propylene oxide adducts such as the “Jeffamines”, cyclohexanediamine and xylylenediamine. The compound having the functional groups may be added to the composition or to the dispersion of the polymer at any point in time. In the aqueous dispersion there is not yet any crosslinking with the keto or aldehyde groups. Crosslinking occurs on the coated substrate only in the course of drying. The amount of the compound having the functional groups is preferably measured such that the molar ratio of the functional groups to the keto and/or aldehyde groups of the polymer is 1:10 to 10:1, especially 1:5 to 5:1, particularly preferably 1:2 to 2:1 and very particularly preferably 1:1.3 to 1.3:1. Especially preferred are equimolar amounts of the functional groups and of the keto and/or aldehyde groups.

The adhesive polymer dispersed in the aqueous phase is preferably a styrene/acrylate copolymer formed from a monomer mixture comprising styrene and at least one monomer selected from C1- to C20-alkyl acrylates and C1- to C20-alkyl methacrylates, for example a monomer mixture comprising or consisting of 40% to 70% by weight of at least one C2- to C8-alkyl acrylate (preferably butyl acrylate or ethylhexyl acrylate), 25% to 55% by weight of styrene and 0.5% to 5% by weight of acid monomers.

Also preferred as adhesive polymers dispersed in the aqueous phase are acrylate polymers formed from a monomer mixture comprising or consisting of 75% to 90% by weight of at least one C2- to C8-alkyl acrylate (preferably ethyl acrylate, butyl acrylate or ethylhexyl acrylate), 5% to 20% by weight of methyl (meth)acrylate and 0.5% to 5% by weight of acid monomers.

The monomers of the polymerization are preferably selected such that the measured glass transition temperature of the adhesive polymer is in the range from −40° C. to +15° C., in particular from −35° C. to +10° C. or from −35° C. to 0° C. or from −10° C. to +10° C. Through targeted variation of monomer type and quantity, those skilled in the art are able according to the invention to produce aqueous polymer compositions whose polymers have a glass transition temperature in the desired range. Orientation is possible using the Fox equation. According to Fox (T. G. Fox, Bull. Am. Phys. Soc. 1956 [Ser. II] 1, page 123 and according to Ullmann's Encyclopedia of Industrial Chemistry, vol. 19, page 18, 4th edition, Verlag Chemie, Weinheim, 1980), the glass transition temperature of copolymers is given to a good approximation by:

1/T_{g}=x¹/T_{g}¹+x²/T_{g}²+ . . . xⁿ/T_{g}ⁿ,

wherein x¹, . . . x², . . . xⁿ are the mass fractions of the monomers 1, 2, . . . n and T_{g}¹, T_{g}², T_{g}ⁿ are the glass transition temperatures in degrees kelvin of the polymers constructed from only one of the monomers 1, 2, . . . n at a time. The T_{g} values for the homopolymers of the majority of monomers are known and are listed for example in Ullmann's Encyclopedia of Industrial Chemistry, vol. 5, vol. A21, page 169, VCH Weinheim, 1992; further sources for glass transition temperatures of homopolymers are, for example, J. Brandrup, E. H. Immergut, Polymer Handbook, 1^{st} Ed., J. Wiley, New York 1966, 2^{nd} Ed. J. Wiley, New York 1975, and 3^{rd} Ed. J. Wiley, New York 1989.

In one embodiment of the invention the free-radical polymerization employs at least one chain transfer agent. This makes it possible to reduce the molar mass of the emulsion polymer through a chain termination reaction. The chain transfer agents are bonded to the polymer in this procedure, generally to the chain end. The amount of the chain transfer agents is especially 0.05 to 4 parts by weight, particularly preferably 0.05 to 0.8 parts by weight and very particularly preferably 0.1 to 0.6 parts by weight, based on 100 parts by weight of the monomers to be polymerized. Suitable chain transfer agents are, for example, compounds having a thiol group such as tert-butyl mercaptan, thioglycolic acid ethylacryl ester, mercaptoethanol, mercaptopropyltrimethoxysilane or tert-dodecyl mercaptan. The chain transfer agents are generally compounds of low molecular mass, having a molar weight of less than 2000, in particularl less than 1000 g/mol. Preferred are 2-ethylhexyl thioglycolate (EHTG), isooctyl 3-mercaptopropionate (IOMPA) and tertdodecyl mercaptan (tDMK).

The polymerization may be carried out with seed control, i.e. in the presence of polymer seed (seed latex). Seed latex is an aqueous dispersion of finely divided polymer particles having an average particle diameter of preferably 20 to 40 nm. Seed latex is used in an amount of preferably 0.01 to 0.5 parts by weight, particularly preferably of 0.03 to 0.3 parts by weight, or of 0.03 to not more than 0.1 parts by weight based on 100 parts by weight of monomers. A latex based on polystyrene or based on polymethyl methacrylate is suitable for example. One preferred seed latex is polystyrene seed.

The emulsion polymerization comprises polymerizing ethylenically unsaturated compounds (monomers) in water using usually ionic and/or nonionic emulsifiers and/or protective colloids or stabilizers as surface-active compounds to stabilize the monomer droplets and the polymer particles subsequently formed from the monomers. The surface-active substances are typically used in amounts of 0.1 to 10 parts by weight, preferably 0.2 to 5 parts by weight, based on 100 parts by weight of the monomers to be polymerized.

A detailed description of suitable protective colloids can be found in Houben-Weyl, Methoden der organischen Chemie [Methods of Organic Chemistry], volume XIV/1, Makromolekulare Stoffe [Macromolecular Materials], Georg-Thieme-Verlag, Stuttgart, 1961, p. 411 to 420. Useful emulsifiers include anionic, cationic and also nonionic emulsifiers. As surface-active substances it is preferable to employ emulsifiers whose molecular weight is typically below 2000 g/mol in contrast with the protective colloids. When mixtures of surface-active substances are used, the individual components must of course be compatible with one another; in case of doubt, this may be checked on the basis of a few preliminary experiments. Preference is given to using anionic and nonionic emulsifiers as surface-active substances. Customary accompanying emulsifiers are for example ethoxylated fatty alcohols (EO degree: 3 to 50, alkyl radical: C₈ to C₃₆), ethoxylated mono-, di- and trialkylphenols (EO degree: 3 to 50, alkyl radical: C₄ to C₉), alkali metal salts of dialkyl esters of sulfosuccinic acid and alkali metal and ammonium salts of alkyl sulfates (alkyl radical: C₈ to C₁₂), of ethoxylated alkanols (EO degree: 4 to 30, alkyl radical: C₁₂ to C₁₈), of ethoxylated alkylphenols (EO degree: 3 to 50, alkyl radical: C₄ to C₉), of alkylsulfonic acids (alkyl radical: C₁₂ to C₁₈) and of alkylarylsulfonic acids (alkyl radical: C₉ to C₁₈).

Further suitable emulsifiers are compounds of the general formula

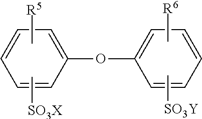

wherein R5 and R6 are hydrogen or C4- to C14-alkyl and are not simultaneously hydrogen, and X and Y may be alkali metal ions and/or ammonium ions. R5 and R6 are preferably linear or branched alkyl radicals having 6 to 18 carbon atoms or hydrogen and in particular having 6, 12 and 16 carbon atoms, wherein R5 and R6 are not both simultaneously hydrogen. X and Y are preferably sodium, potassium or ammonium ions, wherein sodium is particularly preferred. Compounds in which X and Y are sodium, R5 is a branched alkyl radical having 12 carbon atoms and R6 is hydrogen or R5 are particularly advantageous. Often employed are industrial mixtures comprising a proportion of 50% to 90% by weight of the monoalkylated product. Commercially available products of suitable emulsifiers are for example Dowfax® 2 A1, Emulan® NP 50, Dextral® OC 50, Emulgator 825, Emulgator 825 S, EmuIan® OG, Texapon® NSO, Nekanil® 904 S, Lumiten® I-RA, Lumiten® E 3065, Disponil® FES 77, Lutensol® AT 18, Steinapol® VSL, Emulphor® NPS 25. Ionic emulsifiers or protective colloids are preferred for the present invention. Particular preference is given to ionic emulsifiers, in particular salts and acids, such as carboxylic acids, sulfonic acids and sulfates, sulfonates or carboxylates. Also employable in particular are mixtures of ionic and nonionic emulsifiers.

The emulsion polymerization may be initiated using water-soluble initiators. Water-soluble initiators are for example ammonium salts and alkali metal salts of peroxodisulfuric acid, for example sodium peroxodisulfate, hydrogen peroxide or organic peroxides, for example tert-butyl hydroperoxide. Also suitable as initiators are so-called reduction-oxidation (redox) initiator systems. Redox initiator systems consist of at least one generally inorganic reducing agent and an inorganic or organic oxidizing agent. The oxidant component is for example the emulsion polymerization initiators previously recited hereinabove. The reductant components are for example alkali metal salts of sulfurous acid, such as for example sodium sulfite, sodium hydrogensulfite, alkali metal salts of disulfurous acid such as sodium disulfite, bisulfite addition compounds of aliphatic aldehydes and ketones, such as acetone bisulfite or reducing agents such as hydroxymethanesulfinic acid and the salts thereof, or ascorbic acid. The redox initiator systems may be employed with co-use of soluble metal compounds whose metallic component may appear in a plurality of valence states. Typical redox initiator systems are, for example, ascorbic acid/iron(II) sulfate/sodium peroxydisulfate, tert-butyl hydroperoxide/sodium disulfite, tert-butyl hydroperoxide/sodium hydroxymethanesulfinic acid. The individual components, for example the reductant component, may also be mixtures, for example a mixture of the sodium salt of hydroxymethanesulfinic acid and sodium disulfite.

The recited initiators are generally employed in the form of aqueous solutions, the lower concentration limit being determined by the amount of water acceptable in the dispersion and the upper concentration limit being determined by the solubility in water of the particular compound. The concentration of the initiators is generally 0.1% to 30% by weight, preferably 0.5% to 20% by weight, particularly preferably 1.0% to 10% by weight, based on the monomers to be polymerized. It is also possible to use two or more different initiators in the emulsion polymerization.

The emulsion polymerization is preferably carried out at 30° C. to 130° C., preferably at 50° C. to 90° C. The polymerization medium may consist either only of water or of mixtures of water and liquids miscible therewith such as methanol. Preference is given to using solely water. The emulsion polymerization may be carried out in the form of a feed process, including staged or gradient process modes. In the polymerization a polymer seed may be initially charged for more effective adjustment of particle size.

The manner in which the initiator is added to the polymerization vessel over the course of the free-radical aqueous emulsion polymerization is known to those of ordinary skill in the art. It may be either initially charged to the polymerization vessel in its entirety or employed continuously or in a staged manner at the rate of its consumption over the course of the free-radical aqueous emulsion polymerization. This specifically depends on the chemical nature of the initiator system and on the polymerization temperature. Preference is given to initially charging a portion and supplying the remainder to the polymerization zone at the rate of its consumption. In order to remove the residual monomers, it is common after the end of the emulsion polymerization proper, i.e. after a monomer conversion of at least 95%, to add initiator as well. In the feed process, the individual components may be added to the reactor from above, from the side or from below through the reactor floor.

The emulsion polymerization generally affords aqueous dispersions of the polymer having solids contents of from 15% to 75% by weight, preferably from 40% to 60% by weight, particularly preferably not less than 50% by weight.

The polymer thus produced is preferably used in the form of its aqueous dispersion. The size distribution of the dispersion particles may be monomodal, bimodal or polymodal and is preferably monomodal. The average particle diameter of the polymer particles dispersed in the aqueous dispersion is preferably greater than 200 nm, preferably greater than 250 nm, for example from 200 nm to 400 nm or from 250 nm to 350 nm. Average particle diameters x_{PCS} and particle size distribution are measured by photon correlation spectroscopy (ISO standard 13321:1996). The size distribution of the dispersion particles is monomodal when measurement of the particle size distribution contains only one single maximum.

The aqueous laminating adhesive composition may be employed as a one-component composition, i.e. without additional crosslinking agents, in particular without isocyanate crosslinkers. However, the dispersion adhesive composition may also comprise a crosslinkable adhesive polymer dispersed in the aqueous phase and at least one reactive crosslinker. Said composition is then preferably a two-component adhesive where a crosslinking component, such as for example an isocyanate, preferably a water-emulsifiable isocyanate, is added.

Polyurethanes may also be employed as the adhesive polymer. Suitable polyurethane dispersions are in principle obtainable by reaction of at least one polyisocyanate with at least one compound having at least two isocyanate-reactive groups and dispersion in water. Suitable polyurethanes also include so-called polyurethane-polyureas comprising not only polyurethane groups but also urea groups. The polyurethane dispersion preferably comprises at least one polyurethane which comprises at least one polyisocyanate and at least one polymeric polyol in copolymerized form. The polyurethane may in particular be formed from at least one polyisocyanate and at least one polymeric polyol. Suitable polymeric polyols are preferably selected from polyester diols, polyether diols, polycarbonate diols and mixtures thereof. The polymeric polyol preferably has a number-average molecular weight in the range from about 500 to 5000 g/mol. Polymeric diols are preferred. The polyurethane dispersion preferably comprises at least one polyurethane which comprises at least one polyisocyanate and a diol component in copolymerized form, of which a) 10-100 mol % based on the total amount of the diols have a molecular weight of 500 to 5000 g/mol and b) 0-90 mol % based on the total amount of the diols have a molecular weight of 60 to 500 g/mol.

The polyurethane is preferably constructed to an extent of at least 40% by weight, particularly preferably to an extent of at least 60% by weight and very particularly preferably to an extent of at least 80% by weight, based on the total weight of the monomers used for producing the polyurethane, from at least one diisocyanate and at least one polyether diol and/or polyester diol. Suitable further synthesis components to 100% by weight include for example the polyisocyanates recited below having at least three NCO groups and compounds distinct from the polymeric polyols having at least two isocyanate-reactive groups. These include for example diols; diamines; polymers distinct from polymeric polyols having at least two active hydrogen atoms per molecule; compounds having two active hydrogen atoms and at least one ionogenic/ionic group per molecule; and mixtures thereof.

The polyurethane preferably has a softening point or melting point in the range from −50° C. to 150° C., particularly preferably from 0° C. to 100° C. and very particularly preferably from 10° C. to 90° C. It is particularly preferable when the polyurethane has a melting point in the abovementioned temperature range.

Preferred polyurethanes are constructed from:
a) at least one monomeric diisocyanate,
b) at least one diol, wherein the component (b) comprises at least one diol having a number-average molecular weight in the range from 500 to 5000 g/mol,
c) at least one monomer distinct from the monomers (a) and (b) having at least one isocyanate group or at least one isocyanate-reactive group which further bears at least one hydrophilic group or a potentially hydrophilic group,
d) optionally at least one further compound distinct from the monomers (a) to (c) having at least two reactive groups selected from alcoholic hydroxyl groups, primary or secondary amino groups or isocyanate groups, and
e) optionally at least one monofunctional compound distinct from the monomers (a) to (d) having a reactive group which is an alcoholic hydroxyl group, a primary or secondary amino group or an isocyanate group.

The component b) is preferably composed of
b₁) 10 to 100 mol %, based on the total amount of component b), of diols having a molecular weight of 500 to 5000 g/mol,
b₂) 0 to 90 mol %, based on the total amount of component b), of diols having a molecular weight of 60 to less than 500 g/mol.

It is particularly preferable when the ratio of the diols b₁) to the monomers b₂) is 0.1:1 to 5:1, particularly preferably 0.2:1 to 2:1. The diol b) is in particular selected from polytetrahydrofuran, polypropylene oxide and polyesterdiols selected from reaction products of dihydric alcohols with dibasic carboxylic acids and lactone-based polyesterdiols.

Compounds suitable as monomers (a) include in particular diisocyanates X(NCO)₂, wherein X is an acyclic aliphatic hydrocarbon radical having 4 to 15 carbon atoms, a cycloaliphatic or aromatic hydrocarbon radical having 6 to 15 carbon atoms or an araliphatic hydrocarbon radical having 7 to 15 carbon atoms. Examples of such diisocyanates are tetramethylene diisocyanate, hexamethylene diisocyanate, dodecamethylene diisocyanate,1,4-diisocyanatocyclohexane, 5-isocyanato-1-(isocyanatomethyl)-1,3,3-trimethylcyclohexane (IPDI), 2,2-bis(4-isocyanatocyclohexyl)propane, trimethylhexane diisocyanate, 1,4-diisocyanatobenzene, 2,4-diisocyanatotoluene, 2,6-diisocyanatotoluene, 4,4′-diisocyanatodiphenylmethane, 2,4′-diisocyanatodiphenylmethane, p-xylylene diisocyanate, tetramethylxylylene diisocyanate (TMXDI), the isomers of bis(4-isocyanatocyclohexyl)methane (HMDI), such as the trans/trans, the cis/cis and the cis/trans isomers, and mixtures composed of these compounds.

Such diisocyanates are commercially available. Mixtures of these isocyanates of particular importance are the mixtures of the respective structural isomers of diisocyanatotoluene and diisocyanatodiphenylmethane, the mixture of 80 mol % of 2,4-diisocyanatotoluene and 20 mol % of 2,6-diisocyanatotoluene being particularly suitable and preferred. In addition, the mixtures of aromatic isocyanates such as 2,4-diisocyanatotoluene and/or 2,6-diisocyanatotoluene with aliphatic or cycloaliphatic isocyanates, such as hexamethylene diisocyanate or IPDI, are particularly advantageous, the preferred quantitative ratio of the aliphatic isocyanates to aromatic isocyanates being 1:9 to 9:1, in particular 4:1 to 1:4.

The diols (b1) may be polyester polyols and these are known for example from Ullmann's Encyclopedia of Industrial Chemistry, 4th edition, volume 19, pp. 62 to 65. Preference is given to using polyester polyols obtained by reaction of dihydric alcohols with dibasic carboxylic acids. Instead of using the free polycarboxylic acids, the polyester polyols may also be produced using the corresponding polycarboxylic anhydrides or corresponding polycarboxylic esters of lower alcohols or mixtures thereof. The polycarboxylic acids may be aliphatic, cycloaliphatic, araliphatic, aromatic or heterocyclic and may optionally be substituted, for example by halogen atoms, and/or unsaturated. Examples thereof include: suberic acid, azelaic acid, phthalic acid, isophthalic acid, phthalic anhydride, tetrahydrophthalic anhydride, hexahydrophthalic anhydride, tetrachlorophthalic anhydride, endomethylenetetrahydrophthalic anhydride, glutaric anhydride, maleic acid, maleic anhydride, fumaric acid, dimeric fatty acids. Preference is given to dicarboxylic acids of the general formula HOOC—(CH₂)_{y}—COOH, wherein y is a number from 1 to 20, preferably an even number from 2 to 20, for example succinic acid, adipic acid, sebacic acid and dodecanedicarboxylic acid. Suitable dihydric alcohols are, for example, ethylene glycol, propane-1,2-diol, propane-1,3-diol, butane-1,3-diol, butene-1,4-diol, butyne-1,4-diol, pentane-1,5-diol, neopentyl glycol, bis(hydroxymethyl)cyclohexanes such as 1,4-bis(hydroxymethyl)cyclohexane, 2-methylpropane-1,3-diol, methylpentanediols, furthermore diethylene glycol, triethylene glycol, tetraethylene glycol, polyethylene glycol, dipropylene glycol, polypropylene glycol, dibutylene glycol and polybutylene glycols. Preferred alcohols are those of the general formula HO—(CH₂)ₓ—OH, wherein x is a number from 1 to 20, preferably an even number from 2 to 20. Examples thereof are ethylene glycol, butane-1,4-diol, hexane-1,6-diol, octane-1,8-diol and dodecane-1,12-diol. Neopentyl glycol is also preferred.

The diols (b1) may also be polycarbonate diols such as are obtainable for example by reaction of phosgene with an excess of the low molecular weight alcohols recited as synthesis components for the polyester polyols.

The diols (b1) may also be lactone-based polyester diols, specifically homopolymers or copolymers of lactones, preferably terminal hydroxyl-comprising addition products of lactones onto suitable difunctional starter molecules. Contemplated lactones preferably include those derived from compounds of the general formula HO—(CH₂)_{z}—COOH, wherein z is a number from 1 to 20 and one hydrogen atom of a methylene unit may also be substituted by a C₁- to C₄-alkyl radical. Examples include epsilon-caprolactone, beta-propiolactone, gamma-butyrolactone and/or methyl-gamma-caprolactone and mixtures thereof. Suitable starter components are, for example, the low-molecular weight-dihydric alcohols recited hereinabove as synthesis components for the polyester polyols. The corresponding polymers of epsilon-caprolactone are particularly preferred. Lower polyester diols or polyether diols may also be employed as starters for producing the lactone polymers. Instead of the polymers of lactones, the corresponding, chemically equivalent polycondensates of the hydroxycarboxylic acids corresponding to the lactones may also be employed.

The diols (b1) may also be polyether diols. Polyether diols are obtainable in particular by homopolymerization of ethylene oxide, propylene oxide, butylene oxide, tetrahydrofuran, styrene oxide or epichlorohydrin, for example in the presence of BF₃, or by addition of these compounds optionally in admixture or in succession onto starting components having reactive hydrogen atoms, such as alcohols or amines, for example water, ethylene glycol, propane-1,2-diol, propane-1,3-diol, 2,2-bis(4-hydroxyphenyl)propane or aniline. Polyether diols having a molecular weight of 500 to 5000 and especially 600 to 4500 are particularly preferred. Particularly preferred polyether diols are polypropylene oxide and polytetrahydrofuran. Suitable polytetrahydrofurans may be produced by cationic polymerization of tetrahydrofuran in the presence of acidic catalysts, such as for example sulfuric acid or fluorosulfuric acid. Such methods of production are known to those skilled in the art. Suitable compounds b1) further include alpha,omega-diaminopolyethers producible by amination of polyalkylene oxides with ammonia.

b₁) only includes polyether diols formed to an extent of less than 20% by weight, based on their total weight, of ethylene oxide. Polyether diols comprising at least 20% by weight of incorporated ethylene oxide units are hydrophilic polyether diols that are included among the monomers c).

Optionally co-usable as monomers b₁) are also polyhydroxyolefins, preferably those having 2 terminal hydroxyl groups, for example alpha-omega-dihydroxypolybutadiene, alpha-omega-dihydroxypolymethacrylate esters or alpha-omega-dihydroxypolyacrylate esters as monomers. Such compounds are disclosed in EP-A 622 378 for example. Further suitable polyols are polyacetals, polysiloxanes and alkyd resins.

It is preferable when at least 95 mol % of the diols b₁) are polyester diols and/or polytetrahydrofuran. It is particularly preferable to employ exclusively polyesterdiols and/or polytetrahydrofuran as diols b₁).

The hardness and the modulus of elasticity of the polyurethanes can be increased when as diols (b) not only the diols b₁) but also low-molecular-weight diols b₂) having a molecular weight of about 60 to 500, preferably of 62 to 200 g/ml, are employed. Employed monomers b₂) especially include the synthesis components of the short-chain alkanediols recited for the production of polyester polyols, wherein the unbranched diols having 2 to 12 carbon atoms and an even number of carbon atoms and also pentane-1,5-diol and neopentyl glycol are preferred. Contemplated diols b₂) include for example ethylene glycol, propane-1,2-diol, propane-1,3-diol, butane-1,3-diol, butene-1,4-diol, butyne-1,4-diol, pentane-1,5-diol, neopentyl glycol, bis(hydroxymethyl)cyclohexanes such as 1,4-bis(hydroxymethyl)cyclohexane, 2-methylpropane-1,3-diol, methylpentanediols, furthermore diethylene glycol, triethylene glycol, tetraethylene glycol, polyethylene glycol, dipropylene glycol, polypropylene glycol, dibutylene glycol and polybutylene glycols. Preferred alcohols are those of the general formula HO—(CH₂)ₓ—OH, wherein x is a number from 1 to 20, preferably an even number from 2 to 20. Examples thereof are ethylene glycol, butane-1,4-diol, hexane-1,6-diol, octane-1,8-diol and dodecane-1,12-diol. Neopentyl glycol is also preferred.

In order to ensure that the polyurethanes are water-dispersible, the polyurethanes comprise as a synthesis component monomers (c) which are distinct from the components (a) and (b) and bear at least one isocyanate group or at least one isocyanate-reactive group and moreover bear at least one hydrophilic group or a group which can be converted into a hydrophilic group. Hereinbelow, the term “hydrophilic groups or potentially hydrophilic groups” is abbreviated to “(potentially) hydrophilic groups”. The (potentially) hydrophilic groups react with isocyanates substantially more slowly than the functional groups of the monomers used to construct the polymer main chain. The proportion of components comprising (potentially) hydrophilic groups in the total amount of components (a) to (f) is generally measured such that the molar amount of the (potentially) hydrophilic groups (preferably anionic or potentially anionic groups) based on the amount by weight of all monomers (a) to (e) is 30 to 1000, preferably 50 to 500 and particularly preferably 80 to 300 mmol/kg. The (potentially) hydrophilic groups may be nonionic or preferably (potentially) ionic hydrophilic groups.

Contemplated nonionic hydrophilic groups include in particular polyethylene glycol ethers composed of preferably 5 to 100, preferably 10 to 80, ethylene oxide repeating units. The content of polyethylene oxide units is generally 0% to 10% by weight, preferably 0% to 6% by weight, based on the amount by weight of all monomers (a) to (e). Preferred monomers comprising nonionic hydrophilic groups are polyethylene oxide diols comprising at least 20% by weight of ethylene oxide, polyethylene oxide monools and the reaction products of a polyethylene glycol and a diisocyanate which bear a terminally etherified polyethylene glycol radical. Such diisocyanates and processes for their production are recited in patent documents U.S. Pat. No. 3,905,929 and U.S. Pat. No. 3,920,598.

Ionic hydrophilic groups are especially anionic groups, such as the sulfonate, carboxylate and the phosphate group in the form of their alkali metal or ammonium salts, and cationic groups, such as ammonium groups, in particular protonated tertiary amino groups or quaternary ammonium groups. Potentially ionic hydrophilic groups are especially those which may be converted into the abovementioned ionic hydrophilic groups by simple neutralization, hydrolysis or quaternization reactions, i.e. carboxylic acid groups or tertiary amino groups for example. (Potentially) ionic monomers (c) are described in detail for example in Ullmann's Encyclopedia of Industrial Chemistry, 4th edition, volume 19, pp. 311-313 and for example in DE-A 1 495 745.

(Potentially) cationic monomers (c) of particular practical importance are especially monomers comprising tertiary amino groups, for example: tris(hydroxyalkyl)amines, N,N′-bis(hydroxyalkyl)alkylamines, N-hydroxyalkyldialkylamines, tris(aminoalkyl)amines, N,N′-bis(aminoalkyl)alkylamines, N-aminoalkyldialkylamines, wherein the alkyl radicals and alkanediyl units of these tertiary amines are independently of one another composed of 1 to 6 carbon atoms. Also contemplated are polyethers comprising tertiary nitrogen atoms and preferably two terminal hydroxyl groups, such as are obtainable in a manner customary per se for example by alkoxylation of amines comprising two hydrogen atoms attached to amine nitrogen, for example methylamine, aniline or N,N′-dimethylhydrazine. Such polyethers generally have a molar weight of between 500 and 6000 g/mol. These tertiary amines are converted into the ammonium salts either with acids, preferably strong mineral acids such as phosphoric acid, sulfuric acid, hydrohalic acids, or strong organic acids or by conversion with suitable quaternization agents such as C₁ to C₆-alkyl halides or benzyl halides, for example bromides or chlorides.

Contemplated monomers comprising (potentially) anionic groups typically include aliphatic, cycloaliphatic, araliphatic or aromatic carboxylic acids and sulfonic acids bearing at least one alcoholic hydroxyl group or at least one primary or secondary amino group. Preference is given to dihydroxyalkylcarboxylic acids, especially comprising 3 to 10 carbon atoms, as also described in U.S. Pat. No. 3,412,054. Preferred compounds include in particular compounds of the general formula (c₁)

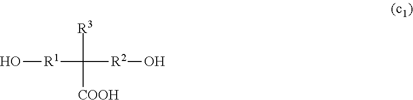

in which R¹ and R² represent a to C₄-alkanediyl (unit) and R³ represents a to C₄-alkyl (unit), especially dimethylolpropionic acid (DMPA). Corresponding dihydroxysulfonic acids and dihydroxyphosphonic acids such as 2,3-dihydroxypropanephosphonic acid are also suitable. Also suitable are dihydroxy compounds having a molecular weight of more than 500 to 10 000 g/mol and comprising at least 2 carboxylate groups, as disclosed in DE-A 39 11 827. These are obtainable by reacting dihydroxy compounds with tetracarboxylic dianhydrides, such as pyromellitic dianhydride or cyclopentanetetracarboxylic dianhydride in a molar ratio of 2:1 to 1.05:1 in a polyaddition reaction. Suitable dihydroxy compounds are in particular the monomers (b2) cited as chain extenders and the diols (b1).

Contemplated monomers (c) comprising isocyanate-reactive amino groups also include aminocarboxylic acids such as lysine, beta-alanine or the adducts, cited in DE-A 20 34 479, of aliphatic diprimary diamines onto alpha,beta-unsaturated carboxylic or sulfonic acids. Such compounds for example conform to the formula (c₂)

H₂N—R⁴—NH—R⁵—X (c₂)

in which R⁴ and R⁵ independently of one another represent a C₁- to C₆-alkanediyl unit, preferably ethylene; and X represents COOH or SO₃H. Particularly preferred compounds of formula (c₂) are N-(2-aminoethyl)-2-aminoethanecarboxylic acid and N-(2-aminoethyl)-2-aminoethanesulfonic acid and the corresponding alkali metal salts, wherein sodium is a particularly preferred counterion. Also particularly preferred are the adducts of the abovementioned aliphatic diprimary diamines onto 2-acrylamido-2-methylpropanesulfonic acid, as described for example in DE-B 1 954 090.

Where monomers containing potentially ionic groups are employed, their conversion into the ionic form may take place before, during, but preferably after the isocyanate polyaddition, since the solubility of the ionic monomers in the reaction mixture is frequently no more than poor. Neutralizing agents are for example ammonia, NaOH, triethanolamine (TEA), triisopropylamine (TIPA) or morpholine, and derivatives thereof. The sulfonate or carboxylate groups are especially preferably present in the form of their salts with an alkali metal ion or with an ammonium ion as the counterion.

The monomers (d) which are distinct from the monomers (a) to (c) and which are optionally also constituents of the polyurethane are generally used for crosslinking or chain extension. They are generally more than dihydric nonphenolic alcohols, amines comprising 2 or more primary and/or secondary amino groups and compounds bearing one or more primary and/or secondary amino groups in addition to one or more alcoholic hydroxyl groups. Alcohols having a hydricity greater than 2 and which may be used to establish a certain degree of branching or crosslinking are, for example, trimethylolpropane, glycerol and sugar.

Also contemplated are monoalcohols which carry not only the hydroxyl group but also a further isocyanate-reactive group such as monoalcohols having one or more primary and/or secondary amino groups, for example monoethanolamine. Polyamines having 2 or more primary and/or secondary amino groups are primarily used when the chain extension and/or crosslinking is to take place in the presence of water since amines generally react with isocyanates more rapidly than alcohols or water. This is often necessary when aqueous dispersions of crosslinked polyurethanes or polyurethanes of high molecular weight are desired. The procedure in such cases comprises producing prepolymers comprising isocyanate groups, rapidly dispersing said prepolymers in water and subsequently chain-extending or crosslinking said prepolymers by adding compounds comprising a plurality of isocyanate-reactive amino groups.

Amines suitable for this purpose are generally polyfunctional amines in the molecular weight range from 32 to 500 g/mol, preferably from 60 to 300 g/mol, which comprise at least two amino groups selected from the group of the primary and secondary amino groups. Examples thereof are diamines such as diaminoethane, diaminopropanes, diaminobutanes, diaminohexanes, piperazine, 2,5-dimethylpiperazine, amino-3-aminomethyl-3,5,5-trimethylcyclohexane (isophoronediamine, IPDA), 4,4′-diaminodicyclohexylmethane, 1,4-diaminocyclohexane, aminoethylethanolamine, hydrazine, hydrazine hydrate or triamines such as diethylenetriamine or 1,8-diamino-4-aminomethyloctane. The amines may also be employed in blocked form, for example in the form of the corresponding ketimines (see, for example, CA-A 1 129 128), ketazines (cf., for example, U.S. Pat. No. 4,269,748) or amine salts (see U.S. Pat. No. 4,292,226). Oxazolidines, as are used, for example, in U.S. Pat. No. 4,192,937, also represent capped polyamines which can be used for producing the polyurethanes according to the invention for chain extension of the prepolymers. Use of such capped polyamines generally comprises mixing said polyamines with the prepolymers in the absence of water and subsequently mixing this mixture with the dispersion water or a portion of the dispersion water, thus releasing the corresponding polyamines hydrolytically. It is preferable to use mixtures of di- and triamines, particularly preferably mixtures of isophorone diamine (IPDA) and diethylene triamine (DETA).

The polyurethanes preferably comprise 1 to 30 mol %, particularly preferably 4 to 25 mol %, based on the total amount of the components (b) and (d) of a polyamine comprising at least 2 isocyanate-reactive amino groups as monomers (d). Higher than difunctional isocyanates may also be used as monomers (d) for the same purpose. Commercially available compounds are, for example, the isocyanurate or the biuret of hexamethylene diisocyanate.

Monomers (e) that are optionally co-used are monoisocyanates, monoalcohols and monoprimary and -secondary amines. The proportion thereof is generally not more than 10 mol%, based on the total molar amount of the monomers. These monofunctional compounds typically bear further functional groups such as olefinic groups or carbonyl groups and serve to introduce functional groups into the polyurethane which make the dispersal or crosslinking or further polymeranalogous reaction of the polyurethane possible. Contemplated therefor are monomers such as isopropenyl-a,a′-dimethylbenzyl isocyanate (TMI) and esters of acrylic or methacrylic acid such as hydroxyethyl acrylate or hydroxyethyl methacrylate.

Coatings having a particularly good profile of properties are obtained especially when the monomers (a) employed are substantially only aliphatic diisocyanates, cycloaliphatic diisocyanates or araliphatic diisocyanates. This monomer combination is superbly complemented as component (c) by alkali metal salts of diaminosulfonic acid; very particularly by N-(2-aminoethyl)-2-aminoethanesulfonic acid and its corresponding alkali metal salts, wherein the Na salt is most suitable, and a mixture of DETA and IPDA as component (d).

Also preferred are polyurethanes, wherein

the diisocyanates a) are selected from diisocyanates of the formula X(NCO)₂, wherein X reprecents an acyclic aliphatic hydrocarbon radical having 4 to 15 carbon atoms, a cycloaliphatic hydrocarbon radical having 6 to 15 carbon atoms, an aromatic hydrocarbon radical having 6 to 15 carbon atoms or an araliphatic hydrocarbon radical having 7 to 15 carbon atoms, preferably selected from the group consisting of hexamethylene diisocyanate, 5-isocyanato-1-(isocyanatomethyl)-1,3,3-trimethylcyclohexane, 2,6-diisocyanatotoluene, 2,4-diisocyanatotoluene and tetramethylxylylene diisocyanate or a mixture thereof;

the diols b1) are selected from polyester diols, polycarbonate diols and polyether diols; and the compound c) is selected from dihydroxycarboxylic acids, diaminocarboxylic acids and diaminosulfonic acids.

The way in which the molecular weight of the polyurethanes may be adjusted through choice of the proportions of the mutually reactive monomers and of the arithmetic mean of the number of reactive functional groups per molecule is common general knowledge in the field of polyurethane chemistry. The components (a) to (e) and their respective molar amounts are normally chosen such that the ratio A:B where
A is the molar amount of isocyanate groups and
B is the sum of the molar amount of hydroxyl groups and the molar amount of functional groups which are capable of reacting with isocyanates in an addition reaction, is 0.5:1 to 2:1, preferably 0.8:1 to 1.5:1, particularly preferably 0.9:1 to 1.2:1. It is very particularly preferable when the ratio A:B is very close to 1:1.

The monomers (a) to (e) employed bear on average typically from 1.5 to 2.5, preferably from 1.9 to 2.1 and particularly preferably 2.0 isocyanate groups or functional groups capable of reacting with isocyanates in an addition reaction.

The polyaddition of the components (a) to (e) to produce the polyurethane is preferably carried out at reaction temperatures of up to 180° C., preferably up to 150° C., under standard pressure or under autogenous pressure. The production of polyurethanes and of aqueous polyurethane dispersions is known to those skilled in the art.

In the context of the present invention an aqueous polyurethane dispersion is to be understood as meaning a dispersion which has an aqueous solvent as the continuous phase. Suitable aqueous solvents are water and mixtures of water with water-miscible solvents, for example alcohols, such as methanol, ethanol, n-propanol, isopropanol, n-butanol, sec-butanol, tert-butanol, n-hexanol and cyclohexanol; glycols, such as ethylene glycol, propylene glycol and butylene glycol; the methyl or ethyl ethers of dihydric alcohols, diethylene glycol, triethylene glycol, polyethylene glycols having number-average molecular weights up to about 3000, glycerol and dioxane, and ketones, such as acetone in particular. In one specific embodiment the polyurethane dispersion is substantially free from organic solvents. “Substantially free from organic solvents” is to be understood as meaning that the proportion of organic solvents is not more than 5% by weight, particularly preferably not more than 1% by weight, in particular not more than 0.1% by weight, based on the total weight of the solvent.

In a preferred embodiment the production of the polyurethanes is carried out in the presence of at least one organic solvent. Preferred organic solvents for production of the polyurethanes are ketones, such as acetone and methyl ethyl ketone, and N-methylpyrrolidone. Particular preference is given to using acetone. If an at least partially water-miscible solvent is used to produce the polyurethanes, the polyurethane dispersion according to the invention may contain not only water but also the organic solvent used for production. It will be appreciated that the production of the polyurethane dispersions according to the invention may be carried out in the presence of at least one organic solvent, with said solvent subsequently being partially or completely replaced with water.

The pH of the laminating adhesive dispersion is preferably adjusted to a pH greater than 5, in particular to a pH between 5.5 and 8.

Preferred laminating adhesive dispersions have a viscosity of 12 s to 26 s, particularly preferably of 13 s to 20 s at 23° C., measured with DIN flow cup no. 4 according to DIN EN ISO 2431:2011.

The aqueous laminating adhesive dispersions may be employed as such or after formulating with customary further auxiliaries which are different from the polyalkylene glycols to be used according to the invention. Typical auxiliaries are, for example, fillers, dyes, leveling agents, thickeners, preferably associative thickeners, defoamers, crosslinking agents, plasticizers, pigments, light stabilizers, biocides, tackifiers or wetting agents. For better wetting of surfaces the dispersions may include in particular wetting auxiliaries (wetting agents), for example fatty alcohol ethoxylates, alkylphenol ethoxylates, nonylphenol ethoxylates, sodium dodecylsulfonates. The amount of further auxiliaries is preferably 0.05% to 5% by weight, especially 0.1% to 3% by weight.

The aqueous laminating adhesive preferably comprises

(i) from 30% to 60% by weight of the at least one adhesive polymer;

(ii) from 0.25% to 3% by weight, particularly preferably from 0.5% to 1.5% by weight, of the at least one polyalkylene glycol dissolved in the aqueous phase; and

(iii) optionally 0-10% by weight of further constituents such as, for example, the abovementioned wetting agents, thickeners, defoamers, crosslinking agents, etc.

In the process according to the invention the adhesive-coated articles may be selected, for example, from laminates, preferably in processes for bonding large-surface-area substrates. Said articles are preferably composite films or glossy films. In the case of composite films, at least two films are bonded to one another using the aqueous dispersion adhesive composition, wherein preferably one or both films are transparent. In the case of glossy films, a transparent film is laminated onto paper or card.

For applications in laminating processes the laminating adhesive is preferably non-self-adhesive. Non-self-adhesive adhesives are adhesives which, unlike pressure-sensitive adhesives, have only very little, if any, tack at room temperature and are preferably employed with application of pressure and/or elevated temperature. The tack measured as loop tack is preferably less than 1.7 N/25 mm (adhesive applied at an application thickness of 20 μm to a 12 μm thick polyester film, measured on steel at room temperature (20° C.) at a peeling speed of 300 mm/min).

The process for producing composite films comprises bonding at least two films to one another using the aqueous laminating adhesive composition. The laminating adhesive composition or a preparation formulated accordingly is preferably applied to the large-surface-area substrates to be bonded at a layer thickness of 0.1 to 20 g/m², particularly preferably 1 to 7 g/m² or 1 to 5 g/m². After a short time for evaporation of the dispersion water (preferably after 1 to 60 seconds) the coated substrate may then be laminated with a second substrate, wherein the temperature may be for example 20° C. to 200° C., preferably 20° C. to 100° C., and the pressure may be for example 100 to 3000 kN/m², preferably 300 to 2000 kN/m².

In the process according to the invention for composite film lamination at least two films are preferably bonded to one another with the aqueous dispersion adhesive composition in such a way that the peel strength (after 24 h, at 23° C/50% rel. humidity) is preferably 2.5 N/15 mm or more or 3 N/15 mm or more or that the films bonded to one another are separable only with destruction of at least one of the films.

In the process according to the invention at least one of the films may be printed or metallized on the side coated with the laminating adhesive composition. Suitable film substrates are, for example, polymer films, in particular made of thermoplastic polyolefins (TPO) such as polyethylene (PE), polypropylene (PP), for example oriented, preferably biaxially oriented, polypropylene (OPP) or unoriented polypropylene (CPP), ethylene/vinyl acetate copolymers (EVA), ASA (acrylonitrite/styrene/acrylate copolymers), PUR (polyurethane), polyamide (PA), polyester, preferably polyethylene terephthalate (PET), polyvinyl chloride (PVC) especially plasticized PVC, polyacetate, poly(meth)acrylates, polycarbonates or their plastic alloys, cellulose acetate, cellophane, polymer films coated (by vapor deposition) with metal, for example aluminum, (metallized films for short) such as metallized polyolefin films or metallized polyester films for example or metal foils, for example made of tin or aluminum. The film substrate is preferably selected from the group consisting of polyethylene, oriented polypropylene, unoriented polypropylene, polyamide, polyethylene terephthalate, polyacetate, cellophane, metallized films and metal foils. The polymer films, in particular polyolefin films, may optionally have been corona pretreated. The films are particularly preferably selected from polyethylene, oriented polypropylene, unoriented polypropylene, polyamide, polyethylene terephthalate, polyacetate and cellophane.

The recited films may be bonded to one another or to a film of another type, for example polymer films to metal foils, different polymer films to one another, etc. The recited films may also have been printed with printing inks for example. The thickness of the film substrates may be for example from 5 to 100 μm, preferably from 5 to 40 μm.

In the case of composite films the material of a first film is selected from OPP, CPP, PE, PET and PA and the material of a second film is selected from OPP, CPP, PE, PET, PA and metal foil for example. In one embodiment of the invention the first film and/or the second film is printed or metallized on the respective side which is coated with the dispersion adhesive composition.

The composite films obtainable according to the invention are suitable especially for the production of flexible packagings, for example for packaging foodstuffs.

Surface treatment of the film substrates before coating with a laminating adhesive composition is not absolutely necessary. However, better results can be obtained if the surfaces of the film substrates are modified prior to coating. Customary surface treatments may be employed in this case to amplify the adhesive effect, for example primers, plasma treatment or corona treatment.

The corona treatment or other surface treatments are carried out to the extent required for sufficient wettability with the coating composition. Customarily, corona treatment of approximately 10 watts per square meter per minute is sufficient for this purpose. Alternatively or in addition it is optionally also possible to use primers or tie coats between film substrate and adhesive coating. Furthermore, other, additional functional layers may be present on the composite films, examples being barrier layers, print layers, color layers or varnish layers, or protective layers. These functional layers may be located externally, i.e. on the side of the film substrate facing away from the adhesive-coated side, or internally, between film substrate and adhesive layer.

Suitable exemplary application weights

for composite film production are:

from 0.1 to 20 g, particularly preferably 1 to 7 g, 1 to 6 g or 1 to 5 g of solid per m² for other technical laminates are:

from 0.5 to 100 g, preferably from 2 to 80 g, very particularly preferably from 10 to 70 g of solid per m².

In addition to the composite film lamination the process according to the invention may also be employed in further industrial lamination processes, for example for producing automotive interior parts, for furniture lamination and for glossy film lamination. Contemplated substrates for bonding then include for example those made of wood, metal, plastic, leather, fiber moldings, for example MDF sheets, or paper. In glossy film lamination transparent polymer films are bonded to paper substrates.

When used for surface decoration of a solid carrier with a film substrate coated according to the invention, for example a decorative film, the film substrate coated according to the invention is bonded for example to articles made of wood, including bound wood fiber materials such as fiberboards or other boards made of cellulose materials, metal or plastic. For example furniture or furniture parts are laminated with the coated film substrate or automotive interior parts are coated with the coated film substrate made of PVC or TPO for example. Polyurethane dispersions are particularly suitable as an adhesive for lamination of rigid shaped articles with flexible decorative films.

The application of the aqueous laminating adhesive compositions on films is carried out using a coating machine having at least one rotating gravure roller, wherein the application system is a gravure roller system wherein the carrier film to be coated moves between two rollers which both rotate in the direction of the moving carrier film web, wherein one of the rollers is a gravure roller and the laminating adhesive is applied from the gravure roller to the carrier film (direct gravure coating system). The gravure roller may be made of metal or ceramic for example. The second roller may be a so-called backing roller and for example may be made of rubber or may have a surface made of rubber. The film coated with laminating adhesive preferably runs through a dryer before a second substrate is colaminated.

The web speed of the film substrate is preferably from 50 to 500 m/min, for example at least 100 m/min, for example from 100 to 400 m/min or from 100 to 300 m/min.

Particular advantages of the process according to the invention are in particular that an optical defect in the coating image can be avoided without the need to employ a mechanical smoothing apparatus in the form of a smoothing roller or a smoothing rod for example. The application system thus preferably does not comprise a mechanical smoothing apparatus.

### EXAMPLES

Input Materials:
Laminating adhesive A 45% aqueous polymer dispersion of a polymer composed of n-butyl acrylate, styrene and acrylic acid having a Tg of −4° C.
Laminating adhesive B 45% aqueous polymer dispersion of a polymer composed of n-butylacrylate, methyl acrylate, methacrylic acid and itaconic acid having a Tg of −32° C.
Loxanol® PL 5824 polypropylene glycol, molecular weight 430 g/mol (miscible with water in any ratio)
Loxanol® PL 5814 polyethylene glycol, molecular weight 400 g/mol (miscible with water in any ratio)
Hydropalat® WE 3162 block copolymer based on polyethylene glycol, polypropylene glycol having an average molecular weight of 2450 g/mol

### Example 1

### Comparison, without Additive

### Laminating Adhesive A

### Example 2

### Comparison without Additive

### Laminating Adhesive B

### Example 3

### Laminating Adhesive A+1% by Weight of Polypropylene Glycol (Loxanol® PL 5824)

### Example 4

### Laminating Adhesive B+2% by Weight of Polypropylene Glycol (Loxanol® PL 5824)

### Example 5

### Laminating Adhesive B+2% by Weight of Polyethylene Glycol (Loxanol® PL 5814)

### Example 6

### Laminating Adhesive B+1% by Weight of Polyethylene/Propylene Glycol (Hydropalat® WE 3162)

Performance Tests:

Film laminates were produced from two clear, transparent 20 μm oPP films

Application weight: 2.5-3 g/m²

Web speed: 200 m/min

Employed gravure roller: 80 lines/cm; line arrangement 45°; theoretical transfer volume 17 ml;
moving in same direction as web,
200 mm diameter

Backing roller: 300 mm diameter, hard rubber coated

Laminating conditions: 6 bar linear pressure at 70° C.

The clarity of the film laminates was subjected to qualitative optical assessment.

−− poor, severe clouding and structuring visible in adhesive

+good, few defects visible

++ very good, no defects visible

The results are summarized in Table 1.

TABLE 1
Visual assessment of composite film laminates

| Example | | Visual assessment |
|---|---|---|
| 1 | Without additive | −− |
| | Laminating adhesive A | |
| 2 | Without additive | −− |
| | Laminating adhesive B | |
| 3 | 1% Loxanol ® PL 5824 | ++ |
| | Laminating adhesive A | |
| 4 | 2% Loxanol PL 5824 | ++ |
| | Laminating adhesive B | |
| 5 | 2% Loxanol PL 5814 | + |
| | Laminating adhesive B | |
| 6 | +1% Hydropalat WE 3162 | −− |

1.-16. (canceled)

17. A process for film lamination comprising applying an aqueous laminating adhesive to a carrier film by means of an application system, wherein the application system is a gravure roller system, wherein the carrier film to be coated moves between two rollers which rotate in the direction of the moving carrier film web, wherein one of the rollers is a gravure roller and the laminating adhesive is applied to the carrier film by the gravure roller, wherein the adhesive-coated carrier film is optionally bonded to a further substrate, wherein the carrier film and/or the optional substrate are optionally transparent or printed,
wherein the aqueous laminating adhesive comprises
(a) at least one adhesive polymer dispersed in the aqueous phase and
(b) at least one polyalkylene glycol dissolved in the aqueous phase, selected from polyethylene glycol, polypropylene glycol and a mixture thereof.

18. The process according to claim 17, wherein the articles produced by bonding to a second substrate are selected from composite films and glossy films.

19. The process according to claim 18, wherein the articles are composite films, wherein at least two films are bonded to one another using the aqueous dispersion adhesive composition, wherein at least one film is transparent.

20. The process according to claim 17, wherein the polyalkylene glycols have a solubility in water of at least 10 g/1 at 20° C.

21. The process according to claim 17, wherein the polyethylene glycol has an average molecular weight of greater than 100 and up to 1500, and wherein the polypropylene glycol has an average molecular weight of greater than 100 and up to 2000.

22. The process according to claim 17, wherein the laminating adhesive comprises
(i) from 30% to 60% by weight of the at least one adhesive polymer and
(ii) from 0.25% to 3% by weight of the at least one polyalkylene glycol dissolved in the aqueous phase.

23. The process according to claim 17, wherein the adhesive polymer has a glass transition temperature of −40° C. to +15° C., measured by differential scanning calorimetry at a heating rate of 20° C./min.

24. The process according to claim 17, wherein the gravure roller is made of metal or ceramic,
the second roller is a backing roller made of rubber or has a rubber surface,
the web speed of the carrier film during coating with adhesive is at least 50 m/min, and
the application quantity of the laminating adhesive is from 1 to 5 g/m².

25. The process according to claim 17, wherein the adhesive polymer is selected from polyurethanes and polymers producible by free-radical emulsion polymerization of ethylenically unsaturated, free-radically polymerizable monomers comprising
a) at least 60% by weight, based on the total amount of monomers, of at least one monomer selected from the group consisting of C1- to C20-alkyl acrylates, C1- to C20-alkyl methacrylates, vinyl esters of carboxylic acids comprising up to 20 carbon atoms, vinylaromatics having up to 20 carbon atoms, vinyl halides, vinyl ethers of alcohols comprising 1 to 10 carbon atoms, aliphatic hydrocarbons having 2 to 8 carbon atoms and one or two double bonds, and mixtures of these monomers,
b) at least 0.1% by weight, based on the total amount of monomers, of at least one monomer having at least one acid group;
c) optionally at least one further monomer distinct from the monomers a) and b).

26. The process according to claim 25, wherein the at least one monomer having at least one acid group is selected from the group consisting of acrylic acid, methacrylic acid, itaconic acid, maleic acid, fumaric acid, crotonic acid, vinylacetic acid, vinyllactic acid, vinylsulfonic acid, styrenesulfonic acid, acrylamidomethylpropanesulfonic acid, sulfopropyl acrylate, sulfopropyl methacrylate and mixtures of these monomers.

27. The process according to claim 17, wherein the adhesive polymer is a polyurethane constructed from
a) at least one monomeric diisocyanate,
b) at least one diol, of which
b1) 10 to 100 mol %, based on the total amount of the diols (b), have a molecular weight of 500 to 5000 g/mol and
b2) 0 to 90 mol %, based on the total amount of the diols (b), have a molecular weight of 60 to 500 g/mol,
c) at least one monomer distinct from the monomers (a) and (b) having at least one isocyanate group or at least one isocyanate-reactive group which further bears at least one hydrophilic group or a potentially hydrophilic group, and
d) optionally at least one further compound distinct from the monomers (a) to (c) having at least two reactive groups selected from alcoholic hydroxyl groups, primary or secondary amino groups or isocyanate groups, and
e) optionally at least one monofunctional compound distinct from the monomers (a) to (d) having a reactive group which is an alcoholic hydroxyl group, a primary or secondary amino group or an isocyanate group.

28. The process according to claim 27, wherein
the diisocyanates a) are selected from diisocyanates of the formula X(NCO)₂, wherein X represents an acyclic aliphatic hydrocarbon radical having 4 to 15 carbon atoms, a cycloaliphatic hydrocarbon radical having 6 to 15 carbon atoms, an aromatic hydrocarbon radical having 6 to 15 carbon atoms or an araliphatic hydrocarbon radical having 7 to 15 carbon atoms;
the diols b1) are selected from polyester diols, polycarbonate diols and polyether diols; and the compound c) is selected from dihydroxycarboxylic acids, diaminocarboxylic acids and diaminosulfonic acids.

29. The process according to claim 27, wherein the diisocyanates are selected from the group consisting of hexamethylene diisocyanate, 5-isocyanato-1-(isocyanatomethyl)-1,3,3-trimethylcyclohexane, 2,6-diisocyanatotoluene, 2,4-diisocyanatotoluene and tetramethylxylylene diisocyanate and a mixture thereof.

30. The process according to claim 17, wherein the adhesive polymer is a polymer producible by free-radical emulsion polymerization of ethylenically unsaturated, free-radically polymerizable monomers comprising
a) 60% to 99.9% by weight, based on the total amount of monomers, of at least one monomer selected from the group consisting of C1- to C20-alkyl acrylates, C1- to C20-alkyl methacrylates, vinylaromatics having up to 20 carbon atoms, and
b) 0.1% to 5% by weight, based on the total amount of monomers, of at least one monomer having at least one acid group selected from acrylic acid, methacrylic acid and itaconic acid and
c) 0% to 10% by weight, based on the total amount of monomers, of further monomers distinct from the monomers a) to b), selected from the group consisting of acrylamide, methacrylamide, N-methylolacrylamide, N-methylolmethacrylamide, phenyloxyethylglycol mono(meth)acrylate, hydroxyl-comprising monomers, amino-comprising monomers, nitriles, alpha,beta-monoethylenically unsaturated C3-C8-carboxylic acids, bifunctional monomers which comprise not only an ethylenically unsaturated double bond but also at least one glycidyl group, oxazoline group, ureido group or ureido-analogous group, and crosslinking monomers having more than one free-radically polymerizable group.

31. The process according to claim 25, wherein the monomers a) are employed in an amount of at least 80% by weight, based on the total amount of the monomers, and are selected from the group consisting of C1- to C10-alkyl acrylates, C1- to C10-alkyl methacrylates, styrene, and a mixture thereof; and the monomers b) are employed in an amount of 0.5% to 5% by weight, based on the total amount of the monomers, and are selected from the group consisting of acrylic acid, methacrylic acid, itaconic acid and a mixture thereof.

32. The process according to claim 17, wherein the laminating adhesive comprises at least one crosslinkable adhesive polymer dispersed in the aqueous phase and at least one reactive crosslinker.

33. The process according to claim 17, wherein the material of the carrier film is selected from the group consisting of polyethylene, oriented polypropylene, unoriented polypropylene, polyamide, polyethylene terephthalate, polyacetate, cellophane.
